(19) United States
(12) Patent Application Publication
(10) Pub. No.: US 2013/0303091 A1
(43) Pub. Date: Nov. 14, 2013

(54) METHOD AND APPARATUS FOR TRANSMITTING AND RECEIVING HIGH FREQUENCY

(71) Applicant: ELECTRONICS AND TELECOMMUNICATIONS RESEARCH INSTITUTE, Daejeon (KR)

(72) Inventors: Seung Sik LEE, Daejeon (KR); Sangsung CHOI, Daejeon (KR); Jae Young KIM, Seoul (KR); Young Ae JEON, Daejeon (KR); cheol-ho SHIN, Daejeon (KR); Sangjae LEE, Daejeon (KR); Byoung Hak KIM, Daejeon (KR); Jaehwan KIM, Daejeon (KR); Mi Kyung OH, Daejeon (KR)

(73) Assignee: Electronics and Telecommunications Research Institute, Daejeon (KR)

(21) Appl. No.: 13/741,940

(22) Filed: Jan. 15, 2013

(30) Foreign Application Priority Data
May 11, 2012 (KR) 10-2012-0050499

(51) Int. Cl. H04B 1/40

(52) U.S. Cl. CPC H04B 1/40
USPC 455/73

(57) ABSTRACT

A high frequency transmitting and receiving apparatus of a wireless communication system low-noise amplifies a signal that is received from a transmitting and receiving antenna through a low noise amplifier in a reception mode, and amplifies a signal be transmitted through a power amplifier in a transmission mode and transmits the signal through the transmitting and receiving antenna, and the high frequency transmitting and receiving apparatus is connected between the transmitting and receiving antenna and the low noise amplifier and turns on a switch in a reception mode and turns off the switch in a transmission mode, thereby separating transmitting and receiving signals.

### CROSS-REFERENCE TO RELATED APPLICATION

This application claims priority to and the benefit of Korean Patent Application No. 10-2012-0050499 filed in the Korean Intellectual Property Office on May 11, 2012, the entire contents of which are incorporated herein by reference.

### BACKGROUND OF THE INVENTION

(a) Field of the Invention

The present invention relates to a method and apparatus for transmitting and receiving a high frequency.

(b) Description of the Related Art

When forming a wireless communication system, a wireless communication system of a chip form is generally formed in consideration of an economic problem.

Because a chip price is determined by area, an increase of a chip area becomes a fatal weakness of price competitive power. Particularly, in a high frequency transceiver of a wireless communication system, an inductor occupies the largest area and thus technology that reduces the number of inductors becomes a core technology.

Further, because a wireless communication system is widely used as a mobile system, power consumption becomes a large element of system performance.

In constituent elements of a high frequency transceiver of a wireless communication system, a power amplifier consumes much more power than other elements due to a characteristic of a final end of a transmitting unit that should output very high power, so power consumption of the power amplifier generally occupies at least a majority of the power consumption of the transceiver. Particularly, because an output signal of the power amplifier passes through a transmitting and receiving conversion switch and a band-pass filter and is transmitted through a transmitting antenna, the power amplifier should amplify with larger power than necessary transmission power, and this causes high power consumption. For example, when a signal loss of the band-pass filter and the transmitting and receiving conversion switch is 3 dBm, in order for a transmitter to provide transmission power of +10 dBm to a transmitting antenna, the power amplifier should provide output power of +13 dBm in consideration of a signal loss (3 dBm) of the band-pass filter and the transmitting and receiving conversion switch.

### SUMMARY OF THE INVENTION

The present invention has been made in an effort to provide a method and apparatus for transmitting and receiving a high frequency having advantages of lowering power consumption of a power amplifier and reducing an area of a chip that is integrated with a high frequency transmitting and receiving apparatus.

An exemplary embodiment of the present invention provides a high frequency transmitting and receiving apparatus of a wireless communication system. The high frequency transmitting and receiving apparatus includes a transmitting and receiving antenna, a low noise amplifier, a power amplifier, and a switch. The low noise amplifier low-noise amplifies a signal that is received through the transmitting and receiving antenna in a reception mode. The power amplifier amplifies a signal be transmitted in a transmission mode and outputs the signal to the transmitting and receiving antenna. The switch is connected between the transmitting and receiving antenna and the low noise amplifier, is turned on in a reception mode, and is turned off in a transmission mode.

The high frequency transmitting and receiving apparatus may further include a load that is connected between the transmitting and receiving antenna and a power voltage source. The switch may be connected between the transmitting and receiving antenna, a contact point of the load, and the low noise amplifier.

The load may perform input impedance matching of a signal that is received through the transmitting and receiving antenna in the reception mode, and perform output impedance matching of a signal that is transmitted through the transmitting and receiving antenna in a transmission mode.

The load may include a capacitor and an inductor that are coupled in parallel between the transmitting and receiving antenna and the power voltage source.

The low noise amplifier may convert a signal that is received through the transmitting and receiving antenna from a single phase signal to a differential phase signal.

The low noise amplifier may include: a first output terminal that outputs a positive signal of the differential phase signal; a second output terminal that outputs a negative signal of the differential phase signal; an input terminal that is connected to the switch; a first amplifier that generates the positive signal by non-inversion amplifying a single phase signal that is input through the input terminal; and a second amplifier that generates the negative signal by amplifying a single phase signal that is input through the input terminal.

Another embodiment of the present invention provides a method of transmitting and receiving a signal in a high frequency transmitting and receiving apparatus of a wireless communication system. The method includes: low-noise amplifying a received signal from a transmitting and receiving antenna through a low noise amplifier in a reception mode; and amplifying a transmitting signal through a power amplifier in a transmission mode and transmitting the transmitting signal through the transmitting and receiving antenna, wherein the transmitting of the transmitting signal includes turning off a switch that is connected between the transmitting and receiving antenna and the low noise amplifier.

The low-noise amplifying of a received signal may include turning on the switch.

The low-noise amplifying of a received signal may include matching an input impedance of the received signal through a first load that is connected between the transmitting and receiving antenna and the low noise amplifier, and the transmitting of the transmitting signal may include matching an output impedance of the amplified signal through a second load that is connected between the transmitting and receiving antenna and the power amplifier.

The high frequency transmitting and receiving apparatus may include a capacitor and an inductor that are coupled in parallel between the transmitting and receiving antenna and the power voltage source, and the first load and the second load may share the capacitor and the inductor, respectively.

The high frequency transmitting and receiving apparatus may be formed in a single chip.

The low-noise amplifying of a received signal may include converting the received signal from a single phase form to a differential phase form.

### BRIEF DESCRIPTION OF THE DRAWINGS

FIG. 1 is a diagram illustrating an RF front end module of a high frequency transmitting and receiving apparatus of a wireless communication system according to an exemplary embodiment of the present invention.

FIG. 2 is a circuit diagram of the high frequency transmitting and receiving apparatus that is shown in FIG. 1.

FIG. 3 is a circuit diagram of an RF front end module of a high frequency transmitting and receiving apparatus according to an exemplary embodiment of the present invention.

FIG. 4 is a diagram illustrating a transmission operation of the high frequency transmitting and receiving apparatus that is shown in FIG. 3.

FIG. 5 is a diagram illustrating a receiving operation of the high frequency transmitting and receiving apparatus that is shown in FIG. 3.

FIG. 6 is a graph illustrating a spectrum of a signal that is transmitted from a high frequency transmitting and receiving apparatus according to an exemplary embodiment of the present invention.

FIG. 7 is a graph illustrating output power and input power of a power amplifier according to an exemplary embodiment of the present invention.

FIG. 8 is a graph illustrating input impedance matching, output impedance matching, and a power gain in a frequency 970 MHz in consideration of chip production of an RF front end module of a high frequency transmitting and receiving apparatus according to an exemplary embodiment of the present invention.

FIG. 9 is a graph illustrating isolation of a high frequency transmitting and receiving apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting and receiving a high frequency according to an exemplary embodiment of the present invention will be described in detail with reference to the drawings.

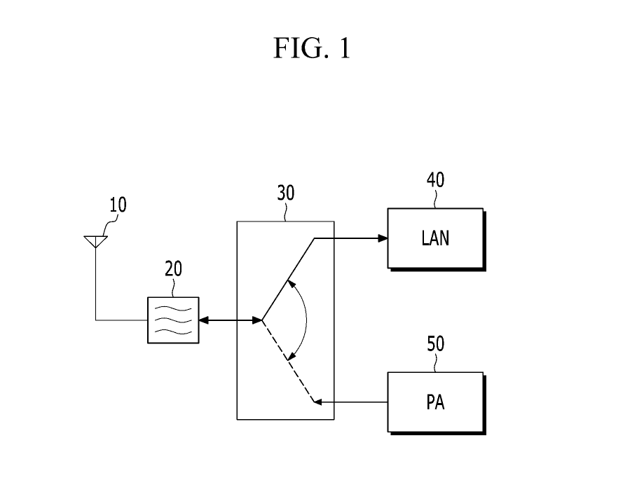

FIG. 1 is a diagram illustrating an RF front end module of a high frequency transmitting and receiving apparatus of a wireless communication system according to an exemplary embodiment of the present invention, and

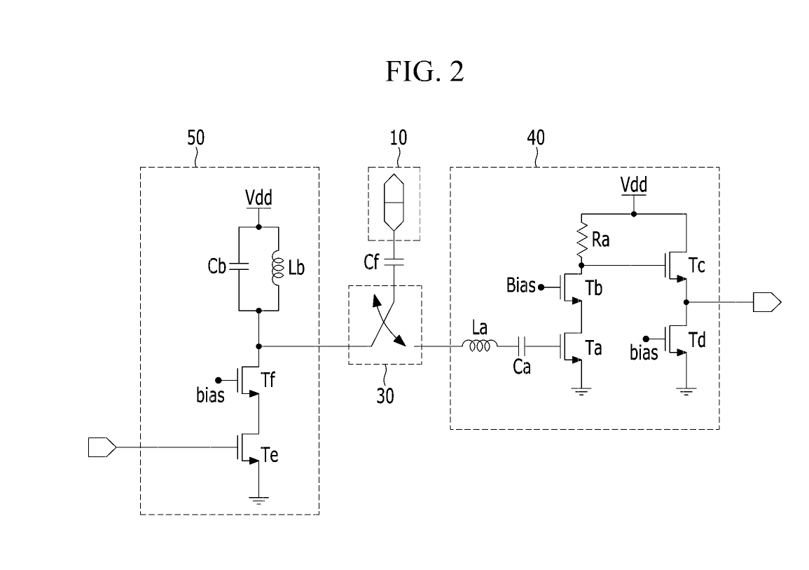

FIG. 2 is a circuit diagram of the high frequency transmitting and receiving apparatus that is shown in FIG. 1.

Referring to FIG. 1, the RF front end module of the high frequency transmitting and receiving apparatus includes a transmitting and receiving antenna 10, a band-pass filter 20, a transmitting and receiving conversion switch 30, a low noise amplifier (LNA) 40, and a power amplifier (PA) 50.

The transmitting and receiving antenna 10 receives or transmits a signal. The transmitting and receiving antenna 10 includes a sector antenna and a sector switch for converting the antenna.

The band-pass filter 20 selects and passes through a frequency of a necessary specific frequency band from the input signal.

The transmitting and receiving conversion switch 30 has one end that is connected to the band-pass filter 20 and the other end that is selectively connected to the LNA 40 or the PA 50 according to a transmitting and reception mode. The transmitting and receiving conversion switch 30 is switched to the LNA 40 in a reception mode and is switched to the PA 50 in a transmission mode. Therefore, in a reception mode, a signal that passes through the band-pass filter 20 is input to the LNA 40, and in a transmission mode, a signal that is amplified by the PA 50 is input to the band-pass filter 20 and is output through the transmitting and receiving antenna 10.

A signal that is received through the transmitting and receiving antenna 10 is low-noise amplified through the LAN 40, and a signal that is output through the transmitting and receiving antenna 10 is amplified through the PA 50 for high output power.

The RF front end module of such a high frequency transmitting and receiving apparatus may be formed using an active circuit element and a passive circuit element, as shown in FIG. 2.

FIG. 2 is a circuit diagram of an RF front end module of the high frequency transmitting and receiving apparatus that is shown in FIG. 1.

As shown in FIG. 2, the band-pass filter 20 may be formed with a capacitor Cf. The capacitor Cf is connected to one end of the transmitting and receiving antenna 10 and the transmitting and receiving conversion switch 30.

The other end of the transmitting and receiving conversion switch 30 is selectively connected to an input terminal of the LAN 40 or an output terminal of the PA 50 according to a transmitting and reception mode.

The LAN 40 may be generally formed with an inductor La, a capacitor Ca, transistors Ta, Tb, Tc, and Td, and a resistor Ra.

The inductor La and the capacitor Ca of the LAN 40 are coupled in series between an input terminal of the LAN 40 and a gate of the transistor Ta, and perform a function of matching an input impedance of the LAN 40 with an output impedance of the transmitting and receiving antenna 10.

Two transistors Ta, Tb/Tc, and Td of the LAN 40 are each connected by a cascode method and operate as an amplifier.

Specifically, the transistor Ta amplifies a signal that is input to a gate and outputs the signal to a drain, and the transistor Tb is turned on by a bias voltage Bias, receives an input of a signal that is amplified by the transistor Ta through a source, and outputs the signal to a drain. The signal that is output through the drain of transistor Tb is input to a gate of the transistor Tc, the transistor Tc amplifies a signal that is input to a gate thereof and outputs the signal to a source, and the transistor Td is turned on by a bias voltage (bias) and outputs a signal that is amplified by the transistor Tc to a drain. The LAN 40 amplifies and outputs a signal while minimizing noise of the signal that is input through the transistors Ta, Tb, Tc, and Td.

The resistor Ra is connected between a power voltage source that supplies a power voltage Vdd and the drain of the transistor Tb and operates as a load, and instead of the resistor Ra, a load, i.e., an LC tank that is formed with an inductor and a capacitor, may be used.

The PA 50 may generally be formed with transistors Te and Tf, a capacitor Cb, and an inductor Lb.

The two transistors Te and Tf of the PA 50 are connected with a cascode method, and amplify and output an input signal. Specifically, a signal be transmitted through the transmitting and receiving antenna 10 is input to a gate of the transistor Te, and the transistor Te amplifies the signal and outputs the signal through a drain. The transistor Tf that is turned on by a bias voltage bias outputs a signal that is amplified by the transistor Te through the drain.

The capacitor Cb and the inductor Lb of the PA 50 are coupled in parallel between a power voltage source that supplies the power voltage Vdd and a drain of the transistor Tf, and operate as a load. This load performs a function of matching output impedance of the PA 50 that is formed with two transistors Te and Tf with input impedance of the transmitting and receiving antenna 10.

In a transmission mode, the other end of the transmitting and receiving conversion switch 30 is connected to an output terminal of the PA 50. Therefore, a signal that is amplified by the PA 50 is transmitted via the capacitor Cf and the transmitting and receiving antenna 10.

In a reception mode, the other end of the transmitting and receiving conversion switch 30 is connected to an input terminal of the LAN 40. Therefore, a signal that passes through the capacitor Ca is input to the LAN 40 and is low-noise amplified.

In this way, a received signal from the transmitting and receiving antenna 10 and a transmitting signal of the transmitting and receiving antenna 10 lose power thereof while passing through the band-pass filter 20 and the transmitting and receiving conversion switch 30.

Particularly, because power loss in a transmitting signal of the transmitting and receiving antenna 10 may generate a receiving error in a receiving stage, the PA 50 amplifies a signal with higher power in consideration of power loss of the band-pass filter 20 and the transmitting and receiving conversion switch 30. Thereby, power consumption of the high frequency transmitting and receiving apparatus increases.

Further, for matching of input impedance of a signal that is input to the LAN 40 and matching of output impedance of a signal that is output from the PA 50, the LAN 40 and the PA 50 use inductors La and Lb, respectively. When an RF front end module of the high frequency transmitting and receiving apparatus is formed in a single chip due to such inductors La and Lb, an area of a chip considerably increases.

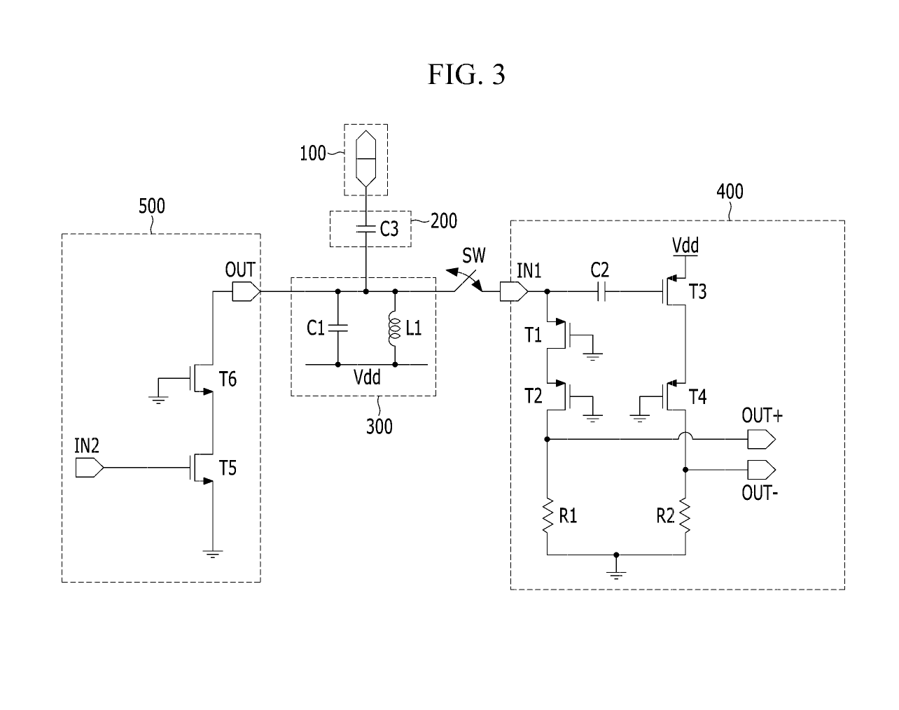

Therefore, when the RF front end module of the high frequency transmitting and receiving apparatus is formed in a single chip, an exemplary embodiment that can reduce an area of the chip and that can reduce power consumption of the high frequency transmitting and receiving apparatus will be described in detail with reference to FIG. 3.

FIG. 3 is a circuit diagram of an RF front end module of a high frequency transmitting and receiving apparatus according to an exemplary embodiment of the present invention.

Referring to FIG. 3, the RF front end module of the high frequency transmitting and receiving apparatus according to an exemplary embodiment of the present invention includes a transmitting and receiving antenna 100, a band-pass filter 200, a load 300, a switch SW, an LNA 400, and a PA 500. Transistors that are used in the LNA 400 and the PA 500 are each a switch having a control terminal, an input terminal, and an output terminal. FIG. 3 illustrates the transistors as an n-channel field effect transistor (FET), and in this case, a control terminal, an input terminal, and an output terminal correspond to a gate, a drain, and a source, respectively.

The band-pass filter 200 includes a capacitor C3. One end of the capacitor C3 is connected to the transmitting and receiving antenna 100, and the other end thereof is connected to the load 300.

The load 300 is connected between the other end of the capacitor C3 and a power voltage source that supplies a power voltage Vdd.

The load 300 includes an inductor L1 and a capacitor C1. The inductor L1 and the capacitor C1 are coupled in parallel between the capacitor C3 and the power voltage source. In FIG. 3, the load 300 includes the inductor L1 and the capacitor C1 that are coupled in parallel, but a structure of the load 300 is not limited thereto and the load 300 may be formed in a series or parallel connection circuit of at least one element or at least two elements of a resistor, an inductor, and a capacitor.

The load 300 performs a function of matching an input impedance of the LNA 400 to an output impedance of the transmitting and receiving antenna 100 in a reception mode, and performs a function of matching an output impedance of the PA 500 to an input impedance of the transmitting and receiving antenna 100 in a transmission mode.

That is, unlike a case of FIG. 2, because one load 300 is used for input impedance matching in a reception mode and output impedance matching in a transmission mode, the number of inductors that are used for impedance matching can be reduced, compared with a case of FIG. 2. Therefore, when the RF front end module is formed in a chip, a size of a chip can be reduced, compared with FIG. 2.

The switch SW has one end that is connected to a contact point between the capacitor C3 and the load 300 and the other end that is connected to the input terminal IN1 of the LNA 400. A controller (not shown) of the high frequency transmitting and receiving apparatus determines a transmitting and reception mode, outputs a control signal that turns on the switch SW to the switch SW in a reception mode, and outputs a control signal that turns off the switch SW to the switch SW in a transmission mode.

The switch SW is turned on in a reception mode and is turned off in a transmission mode according to a control signal from the controller of the high frequency transmitting and receiving apparatus.

In a reception mode, when the switch SW is turned on, a received signal from the transmitting and receiving antenna 100 is input to the LNA 400.

In a transmission mode, when the switch SW is turned off, a transmitting signal of the transmitting and receiving antenna 100 is intercepted from being input to the LNA 400.

In a reception mode, a signal received from the transmitting and receiving antenna 100 is a very weak signal. Therefore, even if a signal received from the transmitting and receiving antenna 100 is input to the PA 500, the received signal has little influence on the PA 500. Therefore, unlike a case of FIG. 2, even if the switch SW is connected between a contact point between the capacitor C3 and the load 300 and an input terminal IN1 of the LNA 400, a transmitting and receiving operation may have no great problem.

However, unlike a case of FIG. 2, when the switch SW is connected between a contact point between the capacitor C3 and the load 300 and the input terminal IN1 of the LNA 400, an output signal of the PA 500 may not pass through the switch SW that causes power loss in a transmission mode and thus power consumption of the PA 50 can be reduced, compared with a case of FIG. 2. Such a switch SW may be included as a portion of the inside of the LNA 400.

The LNA 400 includes an input terminal IN1, output terminals OUT+ and OUT−, transistors T1, T2, T3, and T4, a capacitor C2, and resistors R1 and R2.

The signal that is received through the transmitting and receiving antenna 100 is input to the input terminal IN1 via the band-pass filter 200 and the load 300.

The two transistors T1 and T2 are connected with a cascode method between the input terminal IN1 of the LNA 400 and a ground terminal. A source of the transistor T1 is connected to the input terminal IN1 of the LNA 400, and a drain of the transistor T2 is connected to a positive output terminal OUT+ of a differential output terminal of the LNA 400. A drain of the transistor T1 is connected to a source of the transistor T2, and gates of the transistors T1 and T2 are connected to a bias voltage source that supplies a bias voltage, for example, a constant voltage source.

The transistors T1 and T2 operate as an amplifier of a common gate structure. That is, a signal that is input through a source of the transistor T1 is output through a drain of the transistor T2, which is a positive output terminal OUT+ via the transistor T2. A signal that is output through the drain of the transistor T2 becomes a positive signal of output signals of a differential form.

Further, two transistors T3 and T4 are connected with a cascode method between a power voltage source and a ground terminal. A gate of the transistor T3 is connected to the input terminal IN1 of the LNA 400, and a source of the transistor T3 is connected to a power voltage source that supplies a power voltage Vdd. A drain of the transistor T3 is connected to a source of the transistor T4, a gate of the transistor T4 is connected to the bias voltage source, for example, to a constant voltage source, and a drain of the transistor T4 is connected to a ground terminal. Further, the drain of the transistor T4 is connected to a negative output terminal OUT− of differential output terminals of the LNA 400.

The transistors T3 and T4 also operate as an amplifier. That is, a signal that is input through the gate of the transistor T3 is amplified by a gain of the transistor T4 and is output through the drain of the transistor T4, which is a negative output terminal OUT−. Therefore, a signal that is output through the drain of the transistor T4 becomes a negative signal of output signals of a differential form, and a positive signal and a negative signal have an inverted form.

The resistor R1 is connected between the drain of the transistor T2 which is the positive output terminal OUT+ and a ground terminal, and the resistor R2 is connected between the drain of the transistor T4 which is the negative output terminal OUT− and a ground terminal. The resistors R1 and R2 are each used as a load of the LNA 400, and a load, i.e., an LC tank, which is formed with an inductor and a capacitor, may be used as a load of the LNA 400.

Further, the capacitor C2 performs a function of separately using a DC voltage of the source of the transistor T1 of the LNA 400 and a DC voltage of the gate of the transistor T3.

In the LNA 400, when trans-conductance (gm) values of the two transistors T2 and T4 correspond and values of two resistors R1 and R2 correspond, a gain of an amplifier that is formed with the transistors T3 and T4 and a gain of an amplifier that is formed with the transistors T1 and T2 are the same.

Unlike a case of FIG. 2, the LNA 400 has a function of receiving a single phase signal as an input and converting the signal to a differential phase signal at an output terminal while low-noise amplifying. The differential phase signal has no influence by noise further than a single phase signal. The PA 500 includes an input terminal IN2, an output terminal OUT, and two transistors T5 and T6. A gate of the transistor T5 is connected to the input terminal IN2 of the PA 500, and a drain of the transistor T6 is connected to the output terminal OUT of the PA 500. A source of the transistor T5 is connected to a ground terminal, a drain of the transistor T5 is connected to a source of the transistor T6, and a gate of the transistor T6 is connected to a bias voltage source.

The transistor T5 outputs a signal that is input to the gate through the drain by amplifying by a gain, and the transistor T6 is turned on to output a signal that is amplified by the transistor T5 through a drain, which is the output terminal OUT of the PA 500.

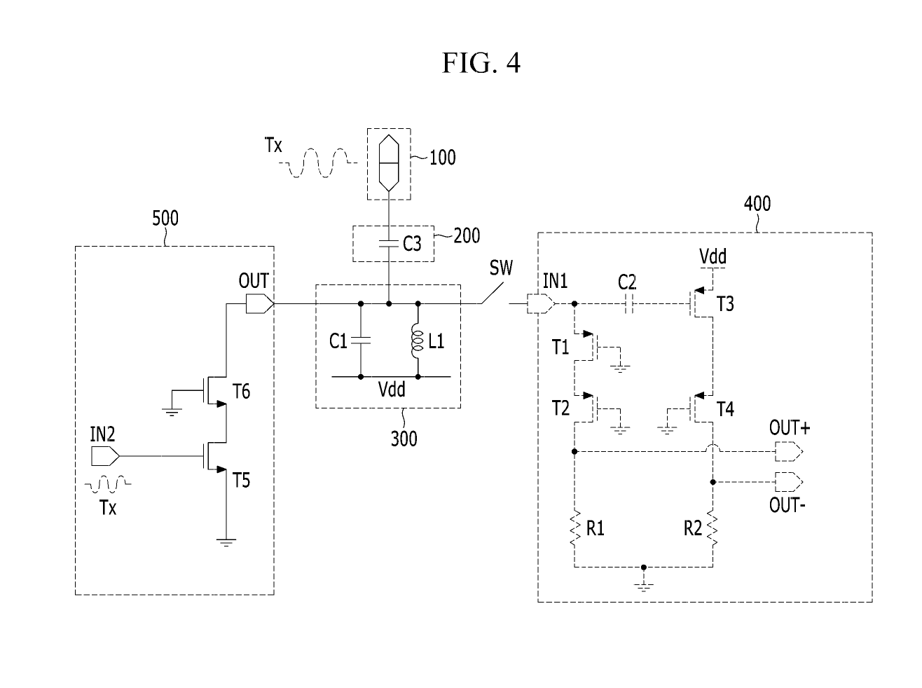

FIG. 4 is a diagram illustrating a transmission operation of the high frequency transmitting and receiving apparatus that is shown in FIG. 3.

Referring to FIG. 4, in a transmission mode, the switch SW is turned off, and a bias voltage that is input to the gate of the transistors T1, T2, T3, and T4 is intercepted, and thus the transistors T1, T2, T3, and T4 are turned off. That is, in a transmission mode, the controller outputs a control signal that turns off the switch SW to the switch SW and stops operation of the LNA 400 by intercepting a bias voltage that is input to the gate of the transistors T1, T2, T3, and T4 of the LNA 400.

When the switch SW is turned off, a signal that is amplified by the PA 500 is not input to the input terminal IN1 of the LNA 400. Therefore, a transmitted and received signal can improve an isolation characteristic.

The controller of the high frequency transmitting and receiving apparatus generates a transmitting signal Tx and outputs the generated transmitting signal Tx to the PA 500.

The signal Tx that is input to the input terminal IN2 of the PA 500 is amplified by two transistors T5 and T6 of the PA 500 and is output to the output terminal OUT of the PA 500.

A signal Tx′ that is amplified by the PA 500 is impedance-matched to impedance of the transmitting and receiving antenna 100 by the load 300, and is band-pass filtered through the capacitor C3. The signal that is band-pass filtered through the capacitor C3 is transmitted through the transmitting and receiving antenna 100.

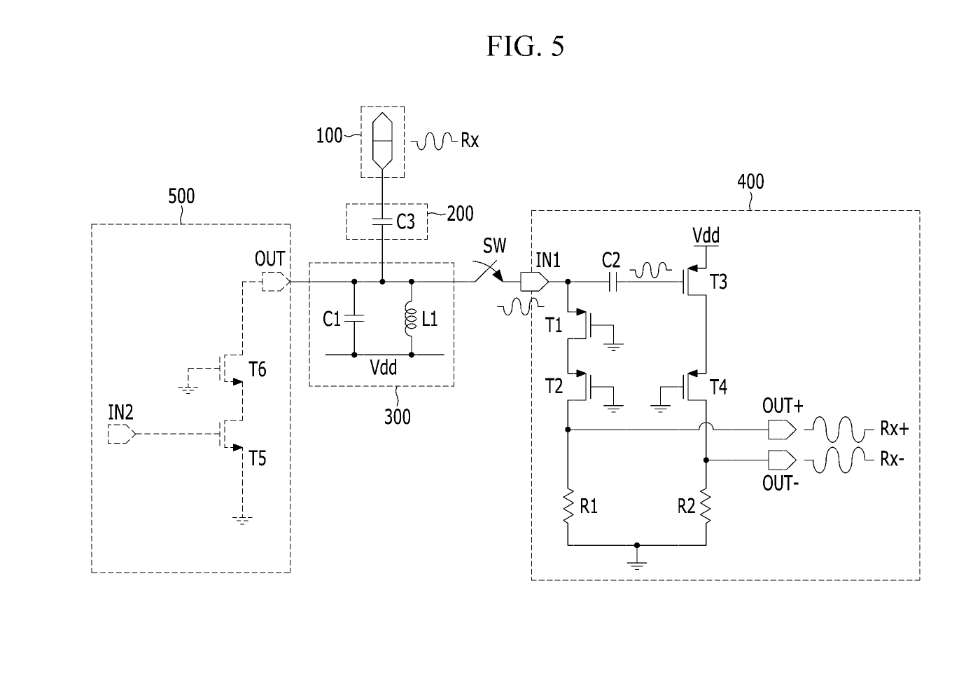

FIG. 5 is a diagram illustrating a receiving operation of the high frequency transmitting and receiving apparatus that is shown in FIG. 3.

Referring to FIG. 5, in a reception mode, the switch SW is turned on to form a signal path from the transmitting and receiving antenna 100 to the LNA 400. Further, in a reception mode, a bias voltage that is input to the gate of the transistors T5 and T6 is intercepted, and thus the transistors T5 and T6 are turned off. That is, in a reception mode, the controller outputs a control signal that turns on the switch SW to the switch SW and stops operation of the PA 500 by intercepting a bias voltage that is input to a gate of the transistors T5 and T6 of the PA 500. Therefore, a DC current flows to only the LNA 400.

In a reception mode, a signal Rx that is received through the transmitting and receiving antenna 100 is band-pass filtered through the capacitor C3, and the band-pass-filtered signal is impedance-matched to impedance of the transmitting and receiving antenna 100 by the load 300.

When the switch SW is turned on, an impedance-matched signal is input to the input terminal IN1 of the LNA 400.

The signal Rx that is input to the input terminal IN1 of the LNA 400 is non-inversion amplified in two transistors T1 and T2 and is output through the positive output terminal OUT+. Further, the signal Rx that is input to the input terminal IN1 of the LNA 400 is amplified by two transistors T3 and T4 and is output through the negative output terminal OUT−.

That is, the LNA 400 non-inversion amplifies and inversion amplifies received signals Rx of the transmitting and receiving antenna 100 and outputs the signals to a positive signal Rx+ and a negative signal Rx−, respectively, of a differential phase.

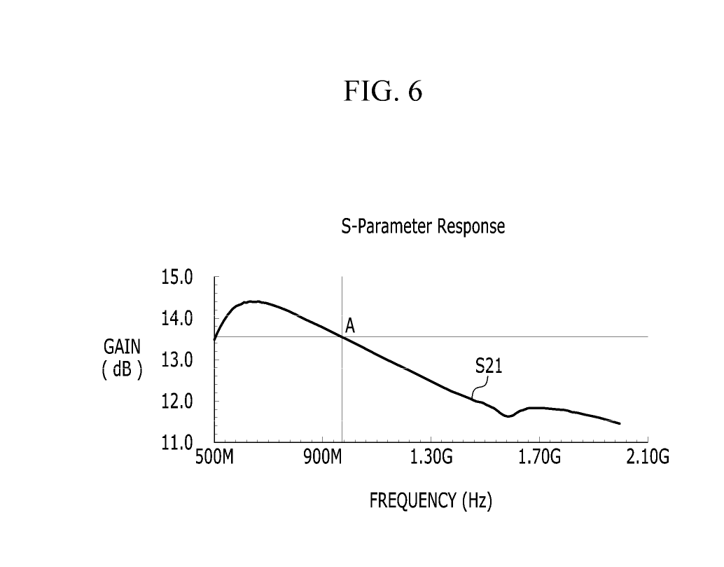

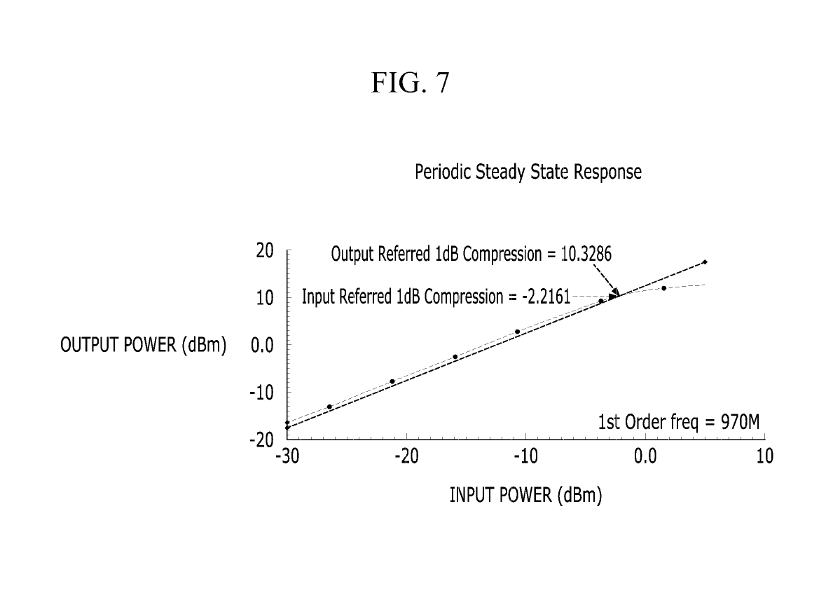

FIG. 6 is a graph illustrating a spectrum of a signal that is transmitted from a high frequency transmitting and receiving apparatus according to an exemplary embodiment of the present invention, and FIG. 7 is a graph illustrating output power and input power of a power amplifier according to an exemplary embodiment of the present invention. FIG. 6 illustrates a result in which the PA 500 simulates a frequency response characteristic, and FIG. 6 shows that in a transmission mode, a gain of the PA 500 is 13.5 dB or more at a frequency 500-900 MHz.

In the existing high frequency transmitting and receiving apparatus of FIG. 2, in order for the PA 50 to make the same gain as that of the PA 500, the PA 50 should have a gain of “13.5 dB+switch loss”.

That is, when it is assumed that the PA 50 of the high frequency transmitting and receiving apparatus of FIG. 2 and the PA 500 of the high frequency transmitting and receiving apparatus of the present invention have the same gain, even if a gain of the PA 500 according to an exemplary embodiment of the present invention is reduced, a result of FIG. 6 can be obtained, and in this case, power consumption can be reduced.

Further, referring to FIG. 7, it can be determined that a maximum output power value of the PA 500 is 10.3 dBm, and a maximum input power value is −2.2 dBm. This graph shows that a maximum output may be transmitted as 10.3 dBm according to an exemplary embodiment of the present invention. That is, even if only one inductor is used, it shows that the same transmission characteristic can be obtained. When a general chip is formed, a constituent element occupying the largest area is an inductor, and thus when reducing the number of inductors according to an exemplary embodiment of the present invention, the same effect can be obtained and thus the present invention has a large economic advantage.

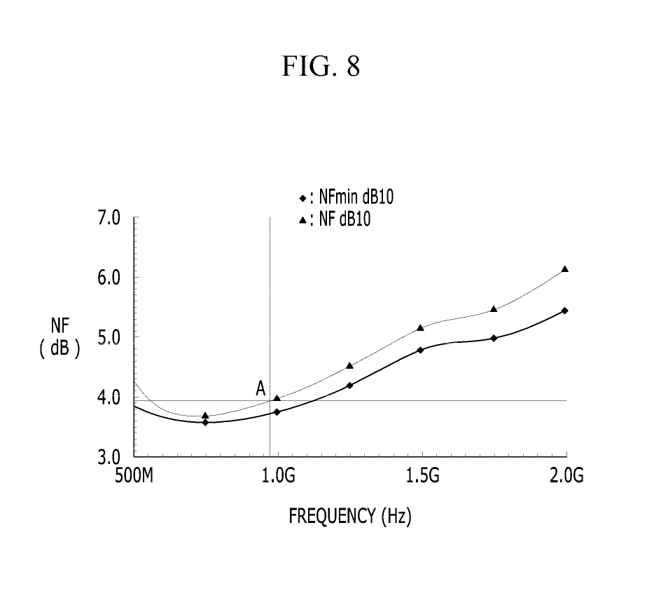

FIG. 8 is a graph illustrating input impedance matching, output impedance matching, and a power gain in a frequency 970 MHz in consideration of chip production of an RF front end module of a high frequency transmitting and receiving apparatus according to an exemplary embodiment of the present invention.

As can be seen through a graph S11 or a graph S22 of FIG. 8, in consideration of chip production of an RF front end module of the high frequency transmitting and receiving apparatus, even if a frequency increases to 970 MHz, it can be seen that both input impedance matching and output impedance matching is less than 10 dB and satisfies a matching condition. That is, it can be seen that both transmitting and receiving impedance is satisfied with one inductor through the graph of FIG. 8.

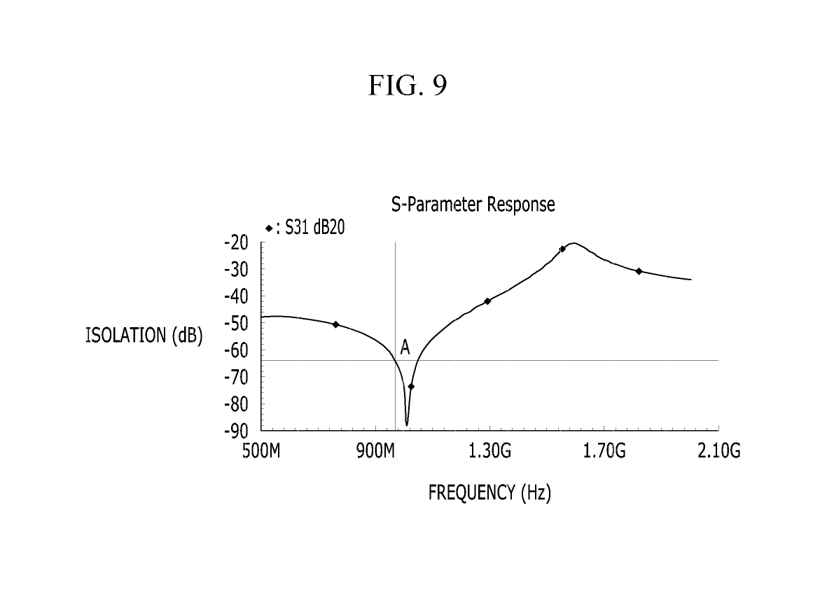

FIG. 9 is a graph illustrating isolation of a high frequency transmitting and receiving apparatus according to an exemplary embodiment of the present invention.

FIG. 9 illustrates a magnitude of a signal that is output from the PA 500 and that arrives at the LNA 400 in a dB scale when the high frequency transmitting and receiving apparatus operates in a transmission mode, and FIG. 9 shows that a magnitude of 47 dB or more is guaranteed in an entire range of 500-900 MHz. That is, FIG. 9 shows that even if the transmitting and receiving conversion switch 30 that is shown in FIG. 2 does not exist, a transmitting and receiving isolation characteristic can be obtained.

According to an exemplary embodiment of the present invention, because a signal loss that is generated by a conventional transmitting and receiving switch can be eliminated, power consumption of a power amplifier can be reduced.

Further, because the number of inductors that a high frequency transmitting and receiving apparatus requires can be reduced, an area of a chip that is integrated with a high frequency transmitting and receiving apparatus can be reduced, and thus a time and a cost for manufacturing a wireless communication system can be reduced.

An exemplary embodiment of the present invention may be not only embodied through the above-described apparatus and/or method but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A high frequency transmitting and receiving apparatus of a wireless communication system, the high frequency transmitting and receiving apparatus comprising:
a transmitting and receiving antenna;
a low noise amplifier that low-noise amplifies a signal that is received through the transmitting and receiving antenna in a reception mode;
a power amplifier that amplifies a signal to be transmitted in a transmission mode and that outputs the signal to the transmitting and receiving antenna; and
a switch that is connected between the transmitting and receiving antenna and the low noise amplifier and that is turned on in a reception mode and that is turned off in a transmission mode.

2. The high frequency transmitting and receiving apparatus of claim 1, further comprising a load that is connected between the transmitting and receiving antenna and a power voltage source,
wherein the switch is connected between the transmitting and receiving antenna, a contact point of the load, and the low noise amplifier.

3. The high frequency transmitting and receiving apparatus of claim 2, wherein the load performs input impedance matching of a signal that is received through the transmitting and receiving antenna in the reception mode, and performs output impedance matching of a signal that is transmitted through the transmitting and receiving antenna in a transmission mode.

4. The high frequency transmitting and receiving apparatus of claim 2, wherein the load comprises a capacitor and an inductor that are coupled in parallel between the transmitting and receiving antenna and the power voltage source.

5. The high frequency transmitting and receiving apparatus of claim 2, wherein the low noise amplifier converts a signal that is received through the transmitting and receiving antenna from a single phase signal to a differential phase signal.

6. The high frequency transmitting and receiving apparatus of claim 5, wherein the low noise amplifier comprises:
a first output terminal that outputs a positive signal of the differential phase signal;
a second output terminal that outputs a negative signal of the differential phase signal;
an input terminal that is connected to the switch;
a first amplifier that generates the positive signal by non-inversion amplifying a single phase signal that is input through the input terminal; and
a second amplifier that generates the negative signal by amplifying a single phase signal that is input through the input terminal.

7. The high frequency transmitting and receiving apparatus of claim 6, wherein the first amplifier comprises:
a first transistor comprising a gate that receives an input of a bias voltage, a source that receives an input of the single phase signal, and a drain that outputs the single phase signal; and
a second transistor comprising a gate that receives an input of a bias voltage, a source that is connected to the drain of the first transistor, and a drain that outputs the positive signal, and
the second amplifier comprises:
a third transistor comprising a gate that receives an input of the single phase signal, a source that is connected to a power voltage source, and a drain that outputs the single phase signal; and
a fourth transistor comprising a gate that receives an input of the bias voltage, a source that is connected to the drain of the third transistor, and a drain that outputs the negative signal.

8. The high frequency transmitting and receiving apparatus of claim 6, wherein the low noise amplifier further comprises a capacitor that separates a DC voltage that is input to the source of the first transistor and a DC voltage that is input to the gate of the third transistor.

9. The high frequency transmitting and receiving apparatus of claim 6, wherein the low noise amplifier further comprises:
a first resistor that is connected between the first output terminal and the power voltage source; and
a second resistor that is connected between the second output terminal and the power voltage source.

10. The high frequency transmitting and receiving apparatus of claim 2, wherein the high frequency transmitting and receiving apparatus is formed in a single chip.

11. A method of transmitting and receiving a signal in a high frequency transmitting and receiving apparatus of a wireless communication system, the method comprising:
low-noise amplifying a received signal from a transmitting and receiving antenna through a low noise amplifier in a reception mode; and
amplifying a transmitting signal through a power amplifier in a transmission mode and transmitting the transmitting signal through the transmitting and receiving antenna,
wherein the transmitting of the transmitting signal comprises turning off a switch that is connected between the transmitting and receiving antenna and the low noise amplifier.

12. The method of claim 11, wherein the low-noise amplifying of a received signal comprises turning on the switch.

13. The method of claim 11, wherein the low-noise amplifying of a received signal comprises matching an input impedance of the received signal through a first load that is connected between the transmitting and receiving antenna and the low noise amplifier, and
the transmitting of the transmitting signal comprises matching an output impedance of the amplified signal through a second load that is connected between the transmitting and receiving antenna and the power amplifier.

14. The method of claim 13, wherein the high frequency transmitting and receiving apparatus comprises a capacitor and an inductor that are coupled in parallel between the transmitting and receiving antenna and the power voltage source, and
the first load and the second load share the capacitor and the inductor, respectively.

15. The method of claim 14, wherein the high frequency transmitting and receiving apparatus is formed in a single chip.

16. The method of claim 11, wherein the low-noise amplifying of a received signal comprises converting the received signal from a single phase form to a differential phase form.
